(19) United States
(12) Patent Application Publication
(10) Pub. No.: US 2013/0186512 A1
(43) Pub. Date: Jul. 25, 2013

(54) MICROFLUIDIC DEVICE WITH A CHAMBER FOR STORING A LIQUID

(71) Applicant: Christian Dorrer, Stuttgart (DE)

(72) Inventor: Christian Dorrer, Stuttgart (DE)

(73) Assignee: Robert Bosch GmbH, Stuttgart (DE)

(21) Appl. No.: 13/556,949

(22) Filed: Jul. 24, 2012

(30) Foreign Application Priority Data
Jul. 25, 2011 (DE) 10 2011 079 698.3

(51) Int. Cl. B01L 3/00

(52) U.S. Cl. CPC B01L 3/50273
USPC 141/2; 422/502; 422/506

(57) ABSTRACT

A microfluidic device has a chamber for storing a liquid. The chamber includes at least in part a hydrophobic surface on an internal wall.

This application claims priority under 35 U.S.C. §119 to patent application no. DE 10 2011 079 698.3, filed on Jul. 25, 2011 in Germany, the disclosure of which is incorporated herein by reference in its entirety

### BACKGROUND

The disclosure is based on a microfluidic device with a chamber for storing a liquid.

Microfluidic devices are used for example as “lab-on-a-chip” systems for environmental analysis or medical analysis. In microfluidic devices liquids are stored and mixed with other liquids.

US 20060029808 discloses superhydrophobic surfaces as an antifouling coating for microfluidic channels. Such a surface comprises a polyelectrolyte multilayer on a substrate.

### SUMMARY

The microfluidic device according to the disclosure, with a chamber for storing a liquid, the chamber comprising at least in part a superhydrophobic surface on an internal wall, has the advantage over previous microfluidic systems that small amounts of liquid, e.g. <100 μl, may be reliably handled. This is made possible in that surface forces acting on the liquid at the internal wall are reduced in such a way that body forces acting on the liquid, for example gravitational force, overcome the surface forces.

A surface is described as hydrophobic if the contact angle between a liquid, in particular water, and the surface amounts to at least 90 degrees. A surface is described as hydrophilic if the contact angle amounts to less than 90 degrees. A surface is described as superhydrophobic if the contact angle amounts to more than 120 degrees, for example more than 150 degrees, for example 175 degrees, and at the same time the contact angle hysteresis, defined as the difference between the advancing and receding contact angles, amounts to less than 50 degrees, for example less than 10 degrees, for example 5 degrees.

The measures described in the dependent claims enable advantageous further developments and improvements to be made to the microfluidic device.

It is particularly advantageous for the chamber to be positioned in such a way in the operating state that at least one junction of a channel leading into the chamber is directed in the direction of a gravitational force and/or centrifugal force acting on the liquid. In this way, small quantities of the liquid collect at the junction into the chamber and may move out of the chamber through the channel.

It is convenient for the junction to be arranged at an internal wall of funnel-shaped or hemispherical construction, so making it easier for a drop of the liquid to roll off towards the junction.

It is particularly advantageous if the microfluidic device comprises a first and a second layer, at least one of the two layers being patterned, and the layers being joined together in such a way that the channel, which leads into the chamber, is formed between them. This simplifies incorporation of the chamber into the microfluidic device.

It is additionally advantageous for the chamber to comprise an orifice for pressure equalization, a pressure force thus being prevented from arising which counteracts movement of the liquid towards the junction.

It is particularly advantageous for the superhydrophobic surface to comprise a contact angle hysteresis of at most 10 degrees. A low contact angle hysteresis results in a drop rolling off the superhydrophobic surface even at low tilt angles. In particular, a combination of a low contact angle hysteresis and a high contact angle for the hydrophobic surface is advantageous, since in this case no drops of liquid remain attached to the internal wall of the chamber.

Conveniently, the superhydrophobic property of the surface is implemented by hydrophobic microparticles applied to the surface, by a hydrophobic polymer layer applied to the surface, by electrospinning of hydrophobic fibers, by introducing micropatterned hydrophobized silicon platelets, by a sol-gel process and/or etching by means of plasma, since these methods of implementation are easy to incorporate into a production process.

### BRIEF DESCRIPTION OF THE DRAWINGS

Exemplary embodiments of the disclosure are explained in more detail in the following description and illustrated in the drawings, in which

FIG. 1 shows a chamber of a microfluidic device according to the disclosure,

FIG. 2 shows a first exemplary embodiment of a microfluidic device according to the disclosure,

FIG. 3 shows a second example of a microfluidic device according to the disclosure and

FIG. 4 shows a third example of a device according to the disclosure,

FIG. 5 shows a fourth example of a device according to the disclosure.

### DETAILED DESCRIPTION

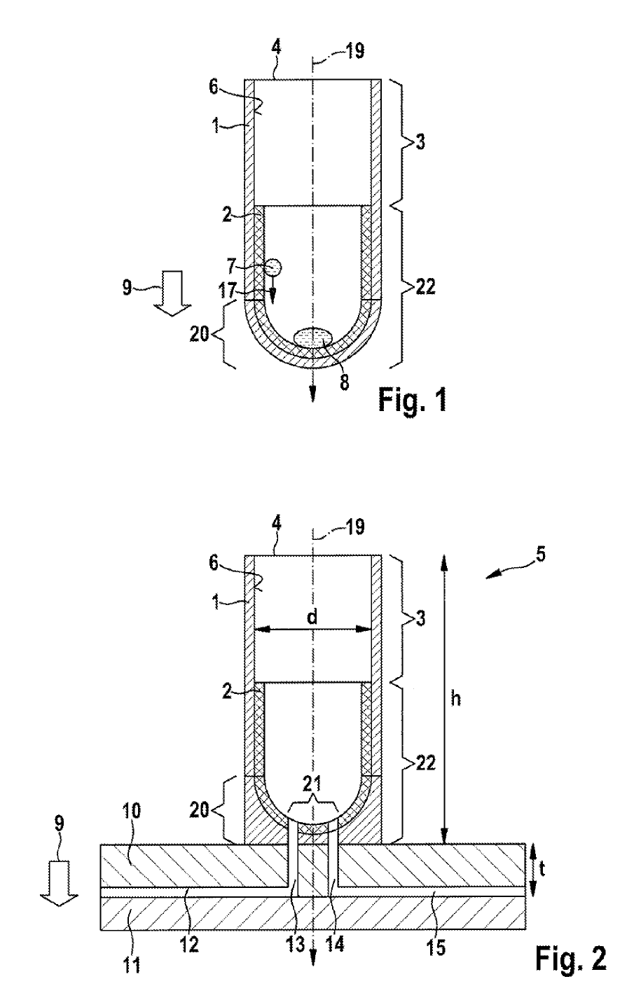

FIG. 1 shows a chamber 1 according to the disclosure of a microfluidic device according to the disclosure for storing a liquid. The chamber 1 is illustrated in its operating state, in which a gravitational force and/or a centrifugal force acts in the direction of an arrow 9. According to FIG. 1 the gravitational and/or centrifugal force 9 acts in a downward direction. The chamber 1 is constructed such that the chamber 1 comprises an orifice 4 at the top according to FIG. 1. According to FIG. 1 the chamber 1 is of hemispherical construction at the bottom 20. An internal wall 6 of the chamber 1 comprises a first zone 22 with a superhydrophobic surface 2 and a second zone 3 with a surface with a lower contact angle than the superhydrophobic surface 2. For example, the surface of the second zone 3 is not superhydrophobic. The chamber 1 is oriented with its bottom 20, which comprises the internal wall of hemispherical construction, in the direction of the gravitational and/or centrifugal force 9. Orientation of the chamber 1 in the direction of the gravitational and/or centrifugal force 9 is taken to mean an orientation of the chamber 1 in which the longitudinal direction 19 of the chamber 1 and the vector of the resultant gravitational and/or centrifugal force 9 forms an angle which is smaller than 45 degrees.

FIG. 1 shows a first quantity of liquid 7 and a second quantity of liquid 8. The gravitational and/or centrifugal force 9 acts on the two quantities of liquid 7 and 8. The quantity of liquid 7, for example a drop with a volume of less than 100 μl, is arranged on the internal wall 6 of the first zone 22 with the superhydrophobic surface 2 of the chamber 1. The first quantity of liquid 7 is remote from the hemispherically constructed bottom 20 of the chamber 1, such that movement of the first quantity of liquid 7 in the direction of the gravitational and/or centrifugal force 9 is not stopped by the internal wall 6 of the chamber 1.

According to FIG. 1, the first liquid 7 therefore moves due to the gravitational and/or centrifugal force 9 acting thereon downwards over the internal wall 6 in the direction of the hemispherically constructed bottom 20 of the chamber 1. The direction of movement of the first quantity of liquid 7 is illustrated by a thin arrow 17. Since the superhydrophobic surface 2 of the chamber 1 reduces the surface force acting on the first liquid 7, the gravitational and/or centrifugal force 9 acts in the form of a body force on the first quantity of liquid 7. The first quantity of liquid 7 does not therefore remain attached to the internal wall 6 of the chamber 1. The second quantity of liquid 8 is located inside the chamber 1 and is arranged in the middle of the hemispherically constructed internal wall 6 of the bottom 20. The second quantity of liquid 8 illustrates the zone in which liquid collects in the chamber due to the gravitational and/or centrifugal force 9 acting thereon. In this operating state, liquids thus collect due to the hydrophobic surface 2 and the gravitational force and/or centrifugal force 9 acting thereon at the hemispherically constructed chamber base.

FIG. 2 shows the chamber 1 according to the disclosure in a microfluidic device 5 according to the disclosure. The microfluidic device 5 comprises the chamber 1, a first, patterned layer 10, a second layer 11, an inlet channel 12, an outlet channel 15 and optionally a cover (not shown). The inlet channel 12 is connected to the interior of the chamber 1 by way of a first opening 13. The outlet channel 15 is connected to the interior of the chamber 1 by way of a second opening 14. The inlet channel 12 and the outlet channel 15 both lead via the two openings 13, 14 into the hemispherically constructed zone of the junction 21 of the internal wall 6 of the chamber 1. As in FIG. 1, the chamber 1 is arranged with its longitudinal axis 19 again taking account of the gravitational force and/or centrifugal force, which acts in the direction of arrow 9. The second layer 11 is arranged on the first layer 10 in such a way that patterns in the first layer 10, which are provided to form the inlet channel 12 and the outlet channel 15, are closed on the side of the patterns facing the second layer 11. In this way, the inlet channel 12 and the outlet channel 15 are formed between the first layer 10 and the second layer 11.

A liquid may then be pumped through the inlet channel 12 and the first opening 13 into the chamber 1. Under the influence of the gravitational and/or centrifugal force 9, the liquid collects in the hemispherically constructed zone 21 inside the chamber 1. The hemispherically constructed zone of the junction 21 of the internal wall 6 forms the chamber base. The liquid collected at the chamber base may then be moved by a positive pressure in the chamber 1 and/or a negative pressure in the outlet channel 15 through the second opening 14 into the outlet channel 15. The superhydrophobic surface 2 of the chamber 1 makes complete emptying thereof possible and prevents the loss of liquid through its remaining in the chamber 1. The hydrophobic surface 2 of the chamber 1 likewise ensures that the chamber 1 is dry after emptying and contamination of the chamber 1 is avoided.

The dimensions according to FIG. 2 for the diameter d of the microfluidic chamber 1 are for example 1 to 20 mm, e.g. 5 mm, for the height h of the chamber 1 for example 5 to 100 mm, e.g. 10 mm, for the height t of the first layer 10 for example 500 μm to 5 mm, e.g. 1 mm, and for a channel diameter of the channels 11, 15, 13, 14 for example 50 to 2000 μm, e.g. 500 μm.

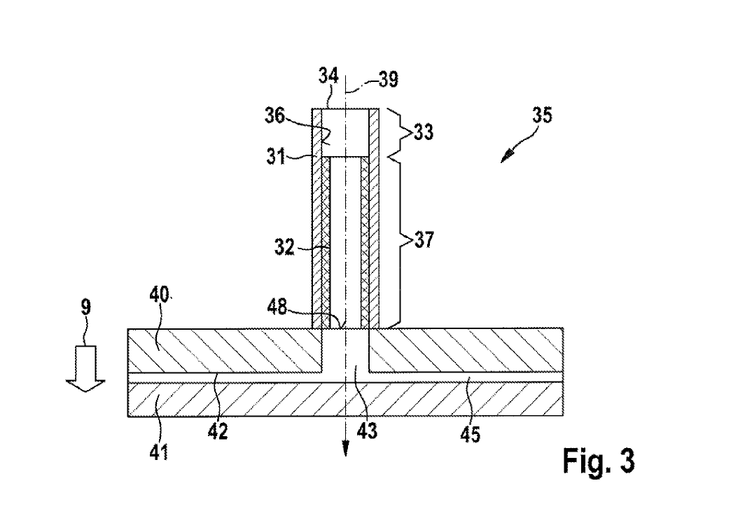

FIG. 3 shows a second embodiment of a microfluidic device 35 according to the disclosure. The microfluidic device 35 comprises a first patterned layer 40, a second layer 41, a chamber 31, an inlet channel 42 and an outlet channel 45. The first layer 40 comprises a hole 43. The chamber 31 comprises an internal wall 36 with a first zone 37 with a superhydrophobic surface 32 and a second zone 33. The first layer 40 is joined to the second layer 41 such that the two channels 42 and 45 are formed between the two layers 40, 41. The microfluidic chamber 31 is brought into fluidic contact by a junction 48 with the inlet channel 42 and the outlet channel 45 via the hole 43 in the first patterned layer 40. The microfluidic chamber 31 is cylindrical, in the form of a tube. The microfluidic device 35 is oriented such that a longitudinal direction 39, which passes through the longitudinal axis of the chamber 31 and whose direction vector points from the chamber 31 towards the hole 43, forms an angle of less than 45 degrees with the vector of the resultant gravitational and/or centrifugal force 9. A liquid may then be pumped by means of the inlet channel 42 via the hole 43 into the chamber 31, if the outlet channel 45 is shut off at the same time. The liquid may be drained out of the chamber 31 via the outlet channel 45, if the inlet channel 42 is closed and the outlet channel 45 is opened simultaneously.

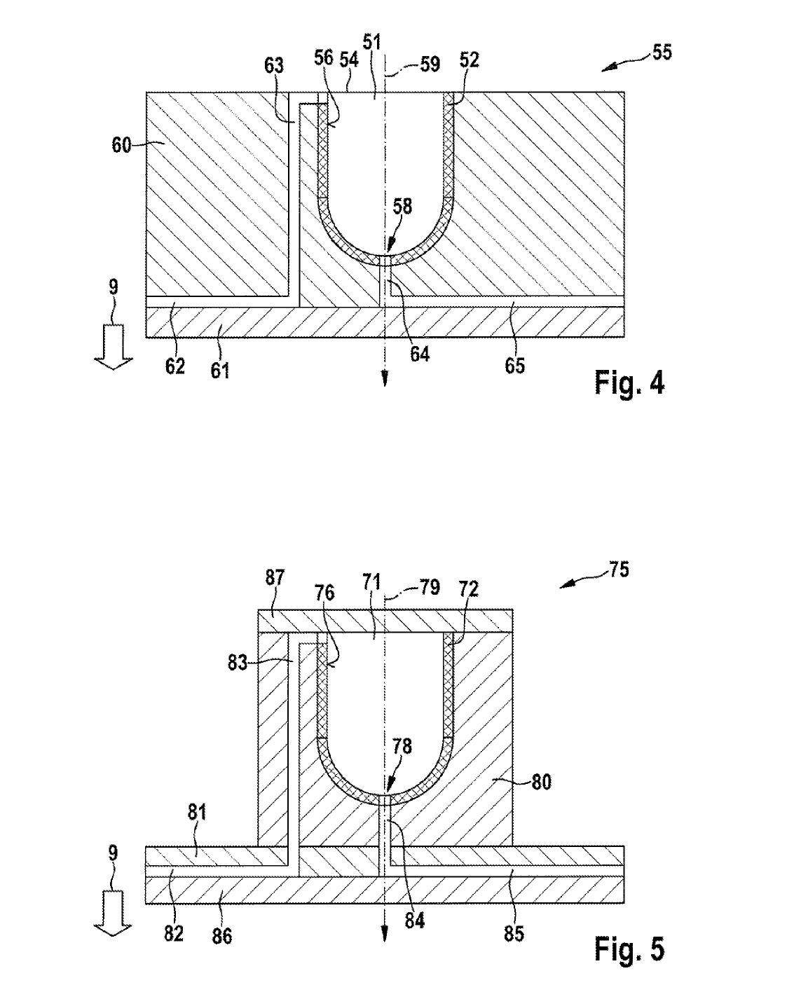

FIG. 4 shows a third embodiment of a microfluidic device 55 according to the disclosure. The microfluidic device 55 comprises a chamber 51 with an internal wall 56 with a superhydrophobic surface 52, an orifice 54, a first patterned layer 60, a second layer 61, an inlet channel 62, an outlet channel 65, a first opening 63 from the inlet channel 62 to the chamber 51 and a second opening 64 from the chamber 51 to the outlet channel 65. The microfluidic chamber 51 is incorporated into the pattern first layer 60. The microfluidic device 55 is oriented, again taking account of the gravitational and/or centrifugal force, which acts in the direction of arrow 9, in a longitudinal direction 59 of the chamber 51, as in the previous embodiments. The outlet channel 65 passes via the second opening 64 at the lower end of the chamber 51 into the chamber 51. This lower end forms a junction 58 and is hemispherical in shape. The first opening 63 from the inlet channel 62 into the chamber 51 is connected in the upper region laterally with the chamber 51. The internal wall 56 of the chamber 51 comprises a superhydrophobic surface 52 throughout. The second layer 61 is arranged on the first layer 60, thereby forming the channels 62 and 65.

FIG. 5 shows a fourth embodiment of a microfluidic device 75 according to the disclosure. The microfluidic device 75 comprises a chamber 71 with an internal wall 76 with a superhydrophobic surface 72, a first patterned layer 80, a second patterned layer 81, an inlet channel 82, an outlet channel 85, a first opening 83 from the inlet channel 82 to the chamber 71, a second opening 84 from the chamber 71 to the outlet channel 85, a third layer 86 and a cover 87. The microfluidic device 75 is oriented, again taking account of the gravitational and/or centrifugal force, which acts in the direction of arrow 9, in a longitudinal direction 79 of the chamber 71, as in the previous embodiments. The outlet channel 82 passes via the second opening 84 at the lower end of the chamber into the chamber 71. This lower end forms a junction 78 and is hemispherical in shape. The first opening 83 from the inlet channel 82 into the chamber 71 is connected in the upper region laterally with the chamber 71. The internal wall of the chamber 71 comprises a superhydrophobic surface 72 throughout. The first layer 80 is patterned such that the first layer 80 forms the chamber 71 and a significant part of the openings 83 and 84. The second layer 81 is patterned such that the second layer 81 forms the inlet channel 82, the outlet channel 85 and part of the openings 83 and 84. The second layer 81 is arranged on the first layer 80 such that the respective parts of the openings 83 and 84 of the first layer 80 and second layer are in fluidic connection. The third layer 86 is arranged on the second layer 81, thereby forming the channels 82 and 85. The cover 87 is arranged on the first layer 80 such that the cover 87 closes the chamber 71 at the top thereof.

A liquid may then be pumped through the inlet channel 82 and the first opening 83 into the chamber 71. Alternatively, a liquid may be pipetted or dispensed into the chamber 71 as early as during production of the microfluidic device 75, prior to application of the cover 87. This has the advantage that simple pre-storage of liquids is possible. Under the influence of the gravitational and/or centrifugal force 9, the liquid collects in the hemispherically constructed zone inside the chamber 71. The liquid collected at the chamber base may then be moved by the application of a positive pressure to the inlet channel 82 and/or a negative pressure in the outlet channel 85 through the second opening 84 into the outlet channel 85.

In further embodiments according to the disclosure the magnitude of the angle between the longitudinal direction 19, 39, 59 of the chamber 1, 31, 51 and the vector of the resultant gravitational and/or centrifugal force 9 is less than 5 degrees.

By means of the device according to the disclosure 5, 35, 51, a liquid, which is for example under the influence of a gravitational force 9 and is located in the chamber 1, 31, 51, may be reliably separated from air bubbles. The air bubbles may escape via the open side of the chamber facing away from the direction of gravitational force.

In a further embodiment according to the disclosure, the surface of the inner side of the chamber comprises a hydrophilic zone, of for example 0.1 to 1 mm, in the area surrounding the mouth of an outlet channel, in order to ensure that the outlet channel is wetted by a liquid.

The first layer 10, 40, 60 and/or the second layer 11, 41, 61 is made for example from a polymer, e.g. a thermoplastic polymer, e.g. polycarbonate, polystyrene, polypropylene or a cyclic olefin copolymer.

In a further embodiment the region of the internal wall of the chamber is funnel-shaped at the bottom.

In a further embodiment, the microfluidic device according to the disclosure comprises a chamber with a superhydrophobic surface on its internal wall and an orifice. A liquid may then be pipetted for example manually or automatically dispensed through the orifice into the chamber. In this way, a user may introduce a sample from outside into the chamber of the microfluidic device. The orifice may optionally then be closed by the user with an adhesive film or a cover.

In a further embodiment, the connection between the chamber and the multilayer assembly is produced only shortly before the microfluidic device is brought into service, for example by clamping, plugging, clipping or adhesively bonding on.

In a further embodiment, the channels are located in the second layer.

Production of a microfluidic device according to the disclosure may proceed for example in that the microfluidic chamber and the first and/or second layer proceeds by injection molding, hot stamping, blow molding and/or milling. Connection of the chamber and the layers may proceed for example by adhesive bonding, lamination and/or welding, in particular solvent, ultrasonic or laser transmission welding.

Production of a superhydrophobic surface for the internal wall of the chamber of a microfluidic device according to the disclosure may proceed, for example by the application of hydrophobized particles (beads), by manufacture of the chamber from polytetrafluoroethylene, etching-on of the surface by means of plasma, roughening of the surface and hydrophobization by application of a thin film of a hydrophobic polymer, electrospinning of hydrophobic fibers, introduction of micropatterned hydrophobized silicon platelets into the internal wall of the chamber and/or a sol-gel process.

In a further embodiment, the microfluidic device may contain further microfluidic, electrical or optical components such as, for example, pumps, mixers, further chambers or reservoirs, biosensors and/or prisms.

What is claimed is:

1. A microfluidic device, comprising:
a chamber configured to store a liquid;
wherein the chamber has an internal wall and includes at least in part a hydrophobic surface or a superhydrophobic surface on the internal wall.

2. The microfluidic device according to claim 1, wherein the chamber is positioned in an operating state in such a way that at least one junction of a channel leading into the chamber is directed in the direction of one or more of a gravitational force acting on the liquid and a centrifugal force acting on the liquid.

3. The microfluidic device according to claim 2, wherein the junction is arranged at an internal wall of funnel-shaped or hemispherical construction.

4. The microfluidic device according to claim 2, further comprising a first layer and a second layer, wherein at least one of the first and second layers is patterned, and wherein the first and second layers are joined together in such a way that the channel is formed between them.

5. The microfluidic device according to claim 1, wherein the chamber includes at least one orifice configured for pressure equalization, application of a positive pressure, or the introduction of liquids.

6. The microfluidic device according to claim 1, wherein the superhydrophobic surface exhibits a contact angle hysteresis of at most 10 degrees.

7. The microfluidic device according to claim 1, wherein the superhydrophobic property of the surface arises as a result of one or more of hydrophobic microparticles applied to the surface, a hydrophobic polymer layer applied to the surface, electrospinning of hydrophobic fibers, the introduction of micropatterned hydrophobized silicon platelets, a sol-gel processes, and etching by use of plasma.

8. A method for filling and emptying a chamber that includes at least in part a superhydrophobic surface on an internal wall, comprising:
orienting the chamber in a field of one or more of a gravitational force and a centrifugal force;
filling the chamber with a liquid via an inlet channel;
storing the liquid in the chamber; and
emptying the chamber via an outlet channel.

9. The method according to claim 8, wherein the chamber is filled with a further liquid before emptying, the further liquid being mixed with the liquid.
